(19) United States
(12) Patent Application Publication
(10) Pub. No.: US 2019/0228748 A1
(43) Pub. Date: Jul. 25, 2019

(54) TUNING METHOD FOR PERCUSSION INSTRUMENT OR SET OF PERCUSSION INSTRUMENTS

(71) Applicant: Drum Workshop, Inc., Oxnard, CA (US)

(72) Inventors: John J. Good, Thousand Oaks, CA (US); Donald G. Lombardi, Oxnard, CA (US)

(21) Appl. No.: 16/255,475

(22) Filed: Jan. 23, 2019

Related U.S. Application Data
(60) Provisional application No. 62/620,960, filed on Jan. 23, 2018.

(51) Int. Cl. G10D 13/02

(52) U.S. Cl. CPC G10D 13/023; G10D 13/028

(57) ABSTRACT

The present disclosure describes a tuning method for a percussion instrument or set of percussion instruments.

### RELATED APPLICATION

The present application claims priority to U.S. Provisional Patent App. No. 62/620,960 to Good et al., filed on Jan. 23, 2018 and entitled “Tuning Method for Percussion Instrument or Set of Percussion Instruments,” the entire contents of which is incorporated by reference herein.

### BACKGROUND

### 1. Field of the Disclosure

The present disclosure relates to musical instruments and the tuning thereof, specifically to percussion instruments and the tuning of percussion instruments, and more specifically to the tuning of percussion instruments such as drums.

### 2. Description of the Related Art

FIG. 1 shows a cross-section of a portion of a prior art drum 10. The drum 10 is generally annular and includes a shell 11 with top and bottom ends 11a,11b and inner and outer walls 11c, 11d. Top and bottom drum heads 12,13 are on top and bottom sides of the drum shell 11, respectively. While the remainder of this disclosure will focus on the top drum head and the tuning thereof, it is understood that the same concepts and/or devices can be applied to tune the bottom drum head 13.

The drum rim 32 is placed over the drum head 12. One or more studs 25 are included on and/or attached to the drum shell 11, such as to the outer wall 11d. A plurality of studs 25 are included at different annular points around the drum shell 11. The drum rim 32 is attached to the remainder of the drum via tensioning rods 36. The tensioning rods 36 pass through the drum rim 32 and attach to the studs 25. The tensioning rods 36 can be screw-like devices, such that the amount of downward pressure on the drum rim 32 is adjustable. Some examples of percussion instruments including drum rims or hoops and methods for using them are described in commonly owned U.S. Pat. App. Pub. No. 2016/0322036 to Good, which is fully incorporated by reference herein in its entirety.

### BRIEF DESCRIPTION OF THE FIGURES

FIG. 1 shows a cross-sectional view of a portion of a drum; and

FIG. 2 shows a cross-sectional view of a drum shell undergoing a testing process.

### DETAILED DESCRIPTION OF THE DISCLOSURE

Disclosed herein are methods of tuning drums, analyzing the natural notes of drum shells and drums, grouping drums based on their natural notes and/or the natural notes of their shells, and producing drum sets including drums with proper intervallic relationships therebetween. These are but some of the methods and devices described herein, and many embodiments of methods and devices according to the present disclosure are possible.

It is understood that when an element is referred to as being “on” another element, it can be directly on the other element or intervening elements may also be present. Further, when one element is referred to as being “connected” to another element, it can be directly connected to the other element or intervening elements may also be present as would be understood by one of skill in the art. Furthermore, relative terms such as “inner”, “outer”, “upper”, “top”, “above”, “lower”, “bottom”, “beneath”, “below”, and similar terms, may be used herein to describe a relationship of one element to another. Terms such as “higher”, “lower”, “wider”, “narrower”, and similar terms, may be used herein to describe angular and/or relative relationships. It is understood that these terms are intended to encompass different orientations of the elements or system in addition to the orientation depicted in the figures.

Although the terms first, second, etc., may be used herein to describe various elements, components, regions and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present disclosure.

Embodiments of the disclosure are described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the disclosure.

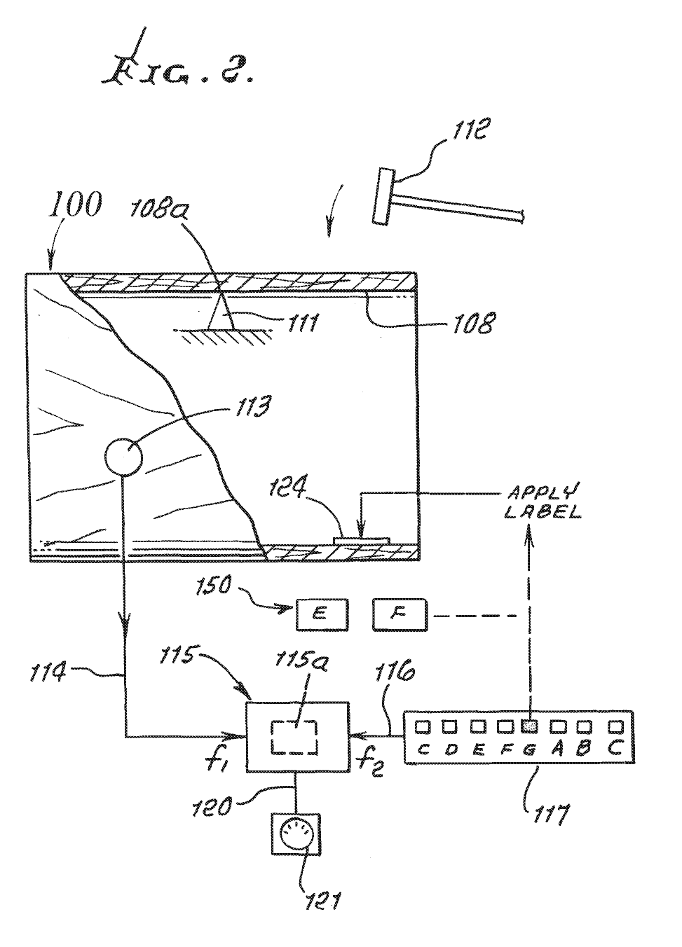

The manufacture of drum shells is known in the art. After the initial steps of drum shell manufacturing where the wood and/or other material is rolled into an open cylinder shape, the drum shell is further prepared by cutting edges, drilling holes, and other procedures to prepare the drum shell for assembly of the completed drum itself. This preparation process results in the drum shell losing mass and being to a certain extent reshaped such that it vibrates at a different acoustic frequency than in its pre-processing phase. Before and/or after this processing is complete, a method according to the present disclosure includes finding the acoustic frequency at which the modified drum shell naturally vibrates, with the vibration often being detectable as sound. As shown in FIG. 2, in order to produce the purest sound, a drum shell 100 (shown in this figure as horizontal) can be held (e.g. suspended) or captured such that it is held only along a limited number of edges (e.g. one edge) or a limited number of points (e.g. one or two points), such as along a knife edge 111, on a tip or point, by a user's hands and/or fingers, by five or fewer fingers, four or fewer fingers, three or fewer fingers, two or fewer fingers, or a single finger, or by any combination thereof. These edges and/or points can be on the inside of the shell, the outside of the shell, and/or one or more edges of the shell. For example, in one embodiment the edge or point(s) can be on the inside surface 108 of the drum shell 100 while the outside surface is struck to produce the vibration and sound, or vice versa. Alternatively, the edge or point(s) can be on the same surface of the drum shell that is struck, whether that be the inside or outside surface. The drum shell can in some embodiments be struck approximately annularly opposite the holding edge or point(s) so as to minimize the impact of the holding edge or point(s) on the produced sound. Vibration and/or sound can also be produced via other methods, such as by putting energy into the shell, which disturbs the shell particles and causes the shell to vibrate at its natural frequency. For instance, another method of vibrating and/or causing sound to emanate from the drum shell is by using forced air.

Once held in a manner so as to produce a relatively pure acoustic frequency, the drum shell's natural acoustic frequency can be matched to a note on the musical scale. A sensor, such as a microphone, can be located near the drum shell when it is struck, and the note produced can then be analyzed to determine its location on the musical scale. Such analysis can be performed, for example, by a comparator. Other methods of identifying the shell's natural note are also possible, including but not limited to ear identification and/or use of a pitch pipe. Many different manners of identifying the frequency at which the shell vibrates and/or the shell's natural note are possible. This process of finding the drum shell's natural vibrating frequency and/or natural note can also be done prior to the described processing of the drum shell to provide an estimate of the drum shell's eventual natural post-processing note. Some embodiments of tuning methods and apparatus, and other methods and apparatus, which may be used in embodiments of the present disclosure are described in commonly owned U.S. Pat. No. 5,770,810 to Lombardi, which is fully incorporated by reference herein in its entirety. Many different embodiments are possible.

The drum shell will produce the highest quality sound as part of a full drum whenever the full drum is tuned so as to produce the drum shell's natural note. Once the drum shell is matched with its natural note, it can be provided with an identifier and/or labeled with this information so as to inform a user of the note at which a drum including the drum shell should be played to produce the highest quality sound. This labeling can be performed utilizing human readable means such as a letter, symbol, and/or musical note notation, which could be included, for example, on a simple sticker, and/or performed utilizing computer readable means such as a barcode or UPC code. Other identification/labeling processes and devices, and other processes and devices generally used for allowing a user to identify the drum shell's natural note, are also possible.

Drum shells can be tested and labeled as a collection to be included as part of a kit or set. For instance, the drum shells can be tested to determine their natural or resonant frequency value, and a label may be affixed to the inside of the drum shell displaying that value or the drum shell's natural note, which can be calculated from the natural or resonant frequency value. For example, a kit can include four tom-toms with different diameters: an 8″ tom, a 10″ tom, a 12″ tom, and a 14″ tom, with larger toms producing lower notes (noting that the methods described herein can also be performed on drum sets including various different sizes, including drum shells with unequal size differences therebetween; for example, a 13″ tom could also be included in the above set). Drum shells with the same or similar natural notes can be grouped together to be manufactured as part of the same kit. Typical drum sizes range from 6″ to 30″ in diameter, though it is understood that sizes outside this range are also possible.

In a kit, it can sometimes be equally or more important to ensure that the intervallic relationship between the different drums is correct, as opposed to or in addition to ensuring that each of the drums is at or near the proper note. For example, it may be better to have all four drums playing slightly flat, as opposed to having two drums playing the desired note and two drums playing slightly flat of the desired note such that the intervallic relationships amongst the various drums are improper. As such, in addition to or in place of grouping based on natural note, grouping can be done to ensure that the proper intervallic relationships are maintained.

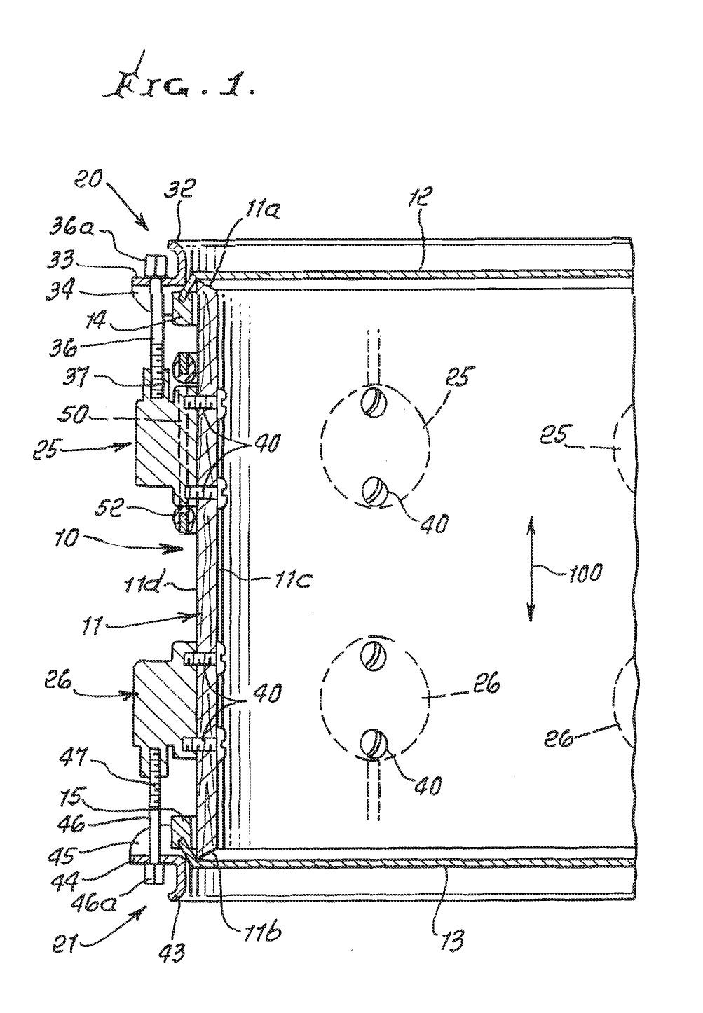

Once individual drum shells are tested using the above methods, drum shells of different sizes can be matched together such that those shells can eventually be used in the same set of drums having proper intervallic relationships therebetween. The drum shells can be grouped prior to and/or after the previously described processing (including, e.g., cutting and shaping). These drum shells can then stay together throughout the manufacturing process (that manufacturing process resulting in drums including, e.g., the elements shown in FIG. 1) to ensure that they are manufactured in a manner consistent with one another, which can aid in maintaining the intervallic relationships properly. Because of the difficulty involved with matching the characteristics of drum shells to be included in a single set, variances for different types of sets can be established, with the set with the lowest permitted variance from the proper intervallic relationships being the most desirable.

After being provided with identifying natural notes, labeled with their natural notes, and/or grouped with other drums having a similar or the same natural notes, the one or more drums can be manufactured/processed using the one or more drum shells to arrive at processed drums similar to the drum shown in FIG. 1. The sound produced by the drums can then be tuned based on the natural notes of their respective drum shell, such as by tuning the top and bottom drum heads of each. In one embodiment, the bottom and top drum heads are tuned approximately to the natural note of the drum shell. In another embodiment, the bottom drum head can be tuned to the natural note while the top drum head can be tuned to be between a quarter and three quarters of a step sharp, and in a more specific embodiment, approximately half a step sharp. The amount of sharpness can be determined based on the energy and/or force used to play the drum head while tuning. In another embodiment, the bottom drum head is tuned to be within a quarter step of the natural note while the top drum head is tuned to be within a step of the natural note. In another embodiment, the bottom drum head and top drum head are tuned to be within one step of one another and/or within one step of the drum shell natural note, and/or within a half step of each other and/or of the drum shell natural note, and/or within a quarter step of each other and/or of the drum shell natural note. The bottom and top drum heads can be tuned so as to have a notes equidistant or not equidistant from the drum shell natural note. Drums according to the present disclosure can include an identifier such as a label to provide the optimal tuning (e.g., a notation that the top drum head should be tuned approximately half a step sharp of the provided natural note, and that the bottom drum head should be tuned approximately to the natural note). These references allow the user to get the optimum resonant frequency value to accommodate the various tuning styles.

Some methods according to embodiments of the present disclosure can include further categorization steps that can take place after the drums are manufactured. For instance, drums can be categorized based on the amount of change in the produced note based on the amount of movement of one or more of the drum's tuning rods. For example, in one embodiment one turn of a drum's tuning rods may cause that drum to be tuned one step sharp or flat of its drum shell's natural note. This drum could in turn be matched with other drums that 1) include a drum shell having the same natural note or a natural note properly intervallically related, and/or 2) also become one step sharp or flat of that natural note upon one turn of the drum's tuning rods. Grouping these drums in such a manner allows the user to adjust all of the tuning rods of a set by the same amount, while maintaining the proper intervallic relationships between the drums. Further, each drum can be provided with an identifier, such as a label, that informs the user of this property of the drum. Drums according to the present disclosure can be identified and/or labeled according to various different attributes thereof, such as identification based on the highest or lowest note to which the drum can reasonably be tuned. Further, drums having two or more consistent qualities can be grouped together; for example, a drum set could be grouped together based on the natural notes of the drum shells and the highest note to which the final drum can be tuned. Many different embodiments are possible.

In one method according to the present disclosure, the preprocessed drum shells (i.e., the open-cylinder shells that have yet to be cut or have holes placed therein) are tested via one or more of the above methods, and grouped based on the discovered natural note. Each group of drum shells is then processed, and tested again via one or more of the above methods, and divided into even smaller subgroups based on the discovered natural note. Drums including the processed drum shells are then manufactured. Finally, the finished drums can be tested via one or more of the above methods and yet again divided such that the drums are grouped with other drums that could form part of the same set. It is understood that while this paragraph describes three evaluation steps, methods according to the present disclosure could include only a single one of these steps, any combination of two of these steps, all three of these steps, additional steps, or none of these steps.

It is understood that various attributes and elements of from any one embodiment can also be included in other embodiments. Although the present disclosure has been described in detail with reference to certain preferred configurations thereof, other versions are possible. The actual scope of the disclosure encompasses not only the disclosed embodiments, but also all equivalent ways of practicing or implementing the disclosure. The above detailed description of the embodiments of the disclosure is not intended to be exhaustive or to limit the disclosure to the precise form disclosed above or to the particular field of usage mentioned in this disclosure. While specific embodiments of, and examples for, the disclosure are described above for illustrative purposes, various equivalent modifications are possible within the scope of the disclosure, as those skilled in the relevant art will recognize. The elements and acts of the various embodiments described above may be combined to provide further embodiments. Further, the teachings of the disclosure provided herein may be applied to products and systems other than percussion instruments, including but not limited to other musical instruments.

We claim:

1. A tuning method for one or more drums each comprising a drum shell, said tuning method comprising:
holding a drum shell such that it is held by an edge or one or more points;
striking said drum shell such that said drum shell vibrates to produce a drum shell sound;
detecting said drum shell sound;
analyzing said drum shell sound and determining a natural note of said drum shell sound based on said analyzing;
producing a drum including said drum shell and a drum head;
striking said drum head to produce a test drum head sound;
analyzing said test drum head sound and determining a note of said test drum head sound; and
tuning said drum head such that said drum head is configured to produce a first drum head sound within a step of said natural note of said drum shell.

2. The tuning method of claim 1, wherein said analyzing comprises analyzing using a comparator.

3. The tuning method of claim 1, wherein said detecting comprises detecting by ear.

4. The tuning method of claim 1, wherein said detecting comprises detecting by microphone.

5. The tuning method of claim 1, wherein said producing comprises producing a drum including said drum shell and first and second drum heads, said striking comprises striking each of said first and second drum heads to produce first and second test drum head sounds, respectively, and said tuning comprises tuning each of said drum heads such said first drum head is configured to produce said first drum head sound and said second drum head is configured to produce a second drum head sound each within a step of said natural note of said drum shell.

6. The tuning method of claim 5, wherein said first drum head is a top drum head and said second drum head is a bottom drum head; and
wherein said tuning comprises tuning said top drum head such that said first drum head sound is sharper than said natural note.

7. The tuning method of claim 5, wherein said first drum head is a top drum head and said second drum head is a bottom drum head; and
wherein said tuning comprises tuning at least one of said top drum head and said bottom drum head such that said first drum head sound is sharper than said second drum head sound.

8. The tuning method of claim 5, wherein said first drum head is a top drum head and said second drum head is a bottom drum head; and
wherein said tuning comprises tuning said top drum head and said bottom drum head such that said first drum head sound is sharper than said second drum head sound.

9. The tuning method of claim 8, wherein said tuning comprises tuning said top drum head and said bottom drum head such that said first drum head sound and said second drum head sound are within a half step of each other and within a half step of said natural note.

10. The tuning method of claim 8, wherein said tuning comprises tuning said top drum head and said bottom drum head such that said first drum head sound is approximately half a step sharper than said natural note and said second drum head sound is approximately at said natural note.

11. A method of grouping drum shells to produce a drum set having proper intervallic relationships, said method comprising:
preprocessing material to form a plurality of preprocessed drum shells;
testing each of said preprocessed drum shells to determine the natural note of each of said preprocessed drum shells;
dividing said preprocessed drum shells into preprocessed drum shell groups based on their natural notes;
cutting and placing holes in the preprocessed drum shells of one of said groups to form processed drum shells; and
testing each of said processed drum shells to determine a natural note of each of said processed drum shells.

12. The method of claim 11, further comprising subdividing said processed drum shells into processed drum shell groups based on their natural notes.

13. The method of claim 12, further comprising forming a set of drums from the drum shells of one of said processed drum shell groups.

14. The method of claim 13, wherein each of said set of drums is produced in a consistent manner such that said set of drums maintains the intervallic relationships from the drum shells.

15. The method of claim 13, wherein said set of drums comprises drums of different diameters, with drums of lower diameter producing sounds having a higher pitch than drums of higher diameter.

16. A method of determining a natural note of a drum shell, said method comprising:
holding a drum shell;
vibrating said drum shell such that said drum shell produces a drum shell sound;
detecting said drum shell sound;
analyzing said drum shell sound and determining a natural note of said drum shell sound based on said analyzing.

17. The method of claim 16, further comprising manufacturing a drum comprising said drum shell.

18. The method of claim 17, wherein said identifier is a label on an inner surface of said drum shell.

19. The method of claim 16, wherein said holding comprises holding such that said drum shell is held by an edge or one or more points.

20. The method of claim 16, further comprising providing said drum shell with an identifier that identifies said natural note.
